(19) United States
(12) Patent Application Publication
(10) Pub. No.: US 2017/0174951 A1
(43) Pub. Date: Jun. 22, 2017

(54) ADHESIVE SYSTEM AND USE OF THE SAME

(71) Applicant: POLYMER SYSTEMS INTERNATIONAL LIMITED, Napier (NZ)

(72) Inventors: Stephen Henry Crawshaw, Napier (NZ); James John Crawshaw, Napier (NZ)

(21) Appl. No.: 14/972,968

(22) Filed: Dec. 17, 2015

(51) Int. Cl. C09J 7/02; C09J 5/00

(52) U.S. Cl. CPC C09J 7/0285; C09J 5/00; C09J 2201/606; C09J 2201/128; C09J 2467/006; C09J 2203/334

(57) ABSTRACT

An adhesive system which includes a layer of a first adhesive overlaid and joined to a layer of a second adhesive. The layer of first adhesive and the layer of second adhesive are preferably joined by being fixed to opposite surfaces of a planar carrier element. The carrier element is preferably a high heat resistant plastics film. In one form of the invention the plastics film is PET.

### BACKGROUND OF THE INVENTION

This invention relates to an adhesive system and the use of same.

The application of a label, graphic or the like (hereinafter for simplicity referred to as a “graphic”) to a plastic article during the moulding thereof in a mould so that the graphic becomes part of the article is known. For example, an in-mould graphic application system is described and claimed in New Zealand patent specification No. 286047 wherein prior to moulding of the article taking place the graphic is adhered by an adhesive to the surface of the mould. During moulding the graphic becomes part of the moulded article such that when the moulded article is removed from the mould the bond between the graphic and the plastic article is greater than the strength or residual strength of the adhesion between the mould and the graphic. As a result the article and the graphic release from the mould as a unit and the face or printed surface of the graphic is on the surface of the moulded article.

In a post moulding operation residual adhesive on the surface of the graphic and the mould surface is removed using a solvent. This type of post moulding operation is time consuming and adds to the cost of the moulding in both time and cost of consumables.

### SUMMARY OF THE INVENTION

An object of the invention is thus to provide an adhesive system that can be used in an in-mould graphic application process and does away with (or at least reduces) post moulding adhesive removal or at least provides the public with a useful choice.

Another object of the invention is to provide a method of use of such an adhesive system in an in-mould graphic application process.

The present invention is based on the discovery that the need to remove adhesive from the surface of the graphic and/or mould surface can be avoided or at least be reduced by the use of an adhesive system that peels away adhesive from a surface to which it has been applied and leave no residual (or very little residual) adhesive on the surface.

Broadly in one aspect of the invention there is provided an adhesive system which includes a layer of a first adhesive overlaid and joined to a layer of a second adhesive.

In the preferred form of the invention the layer of first adhesive and the layer of second adhesive are joined by being fixed to opposite surfaces of a planar carrier element.

Preferably the carrier element is a high heat resistant plastics film.

In one form of the invention the plastics film is PET.

In one form of the invention the first adhesive is of lower tack than that of the second adhesive.

Such an adhesive system can be used in rotational, injection, thermo film and blow plastic moulding operations in which a graphic is to be applied in-mould so as to become part of the article that is moulded in the mould.

The moulding operator can prepare its own adhesive system by applying the first adhesive to one side of a carrier and the second adhesive to the other side of the carrier. The second adhesive side can then be adhered to the face (printed) surface of the graphic in preparation for the graphic to be installed in the mould. Installation in the mould is effected by the first adhesive adhering the graphic to the mould surface.

However, a preformed adhesive system will simplify and speed up preparation of the graphic for installation and the overall moulding operation.

Therefore in a second aspect of the invention there is broadly provided an adhesive system which includes a layer of a first adhesive, a layer of second adhesive, the first adhesive and the second adhesive being located and retained on respective opposite surfaces of a planar high heat resistant carrier.

In the preferred form each of the exposed surfaces of each adhesive layer is covered by a removable backing material.

In one form of the invention the first adhesive is of lower tack than that of the second adhesive.

The first and second adhesives can in one embodiment of the invention be the same. The thickness of the layer of the first adhesive can in one preferred embodiment be less than the thickness of the layer of second adhesive.

Preferably in the adhesive system according to this second broad aspect the first adhesive is a touch sensitive adhesive.

Preferably in the adhesive system according to this second broad aspect the carrier is a high heat resistant plastics film such as a PET film.

In a preferred form the PET film is clear.

Broadly in a third aspect of the invention there is provided a graphic which includes a substrate a surface of which has printing (such as graphics, indicia, wording and the like) applied thereto and to this printed surface is adhered the second adhesive side of an adhesive system according to the first or second broad aspect above.

In one form of the invention the substrate is a synthetic paper.

In another form of the invention the substrate is a clear material.

In a fourth broad aspect there is provided a process of in-mould application of a graphic to a moulded plastic article including the steps of applying to a printed surface of a graphic substrate the second adhesive side of an adhesive system according to the first or second broad aspects above, adhering the graphic to a surface of the mould by way of the first adhesive, removing the moulded article from the mould at the completion of the moulding cycle and peeling the adhesive system from the graphic or the mould.

### BRIEF DESCRIPTION OF THE DRAWINGS

FIG. 1 is cross sectioned illustration of a graphic incorporating the adhesive according to the invention, and

FIG. 2 is an exploded isometric view of the graphic incorporating the adhesive.

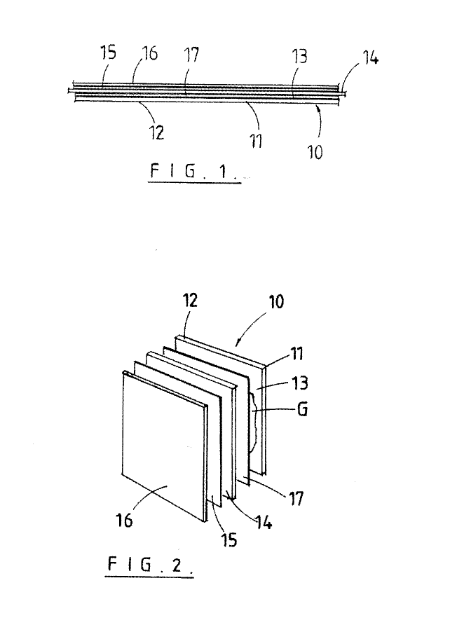

### DESCRIPTION OF PREFERRED EMBODIMENTS OF THE INVENTION

In the following more detailed description of embodiments of an adhesive system in accordance with the present invention, a graphic employing the adhesive system, and a method of using the graphic, reference will be made to the aforementioned drawing. The drawing is for the purposes of illustration of the components of the adhesive system and graphic and is thus on an enlarged scale and is not necessarily accurate dimensionally.

In the drawings there is shown one embodiment of a graphic incorporating the adhesive system according to the invention. It will be appreciated by the skilled addressee that an adhesive system according to the invention and its use with a graphic and a method of moulding a plastic article with a graphic can be achieved by way of embodiments, which differ from that which is described and illustrated in the present specification.

In the drawings there is shown a graphic 10 incorporating a substrate 11 that has a surface 12 which will, when the graphic 10 has been applied during a moulding process to the moulded article, be the surface which is moulded into the article. The opposite surface 13 of the substrate 11 (which is the surface that will be adhered to the surface of the mould) will be the surface of the graphic 10 that is visible on the moulded article and on which indicia, printing, wording etc. G of the graphic will be located.

As is known the indicia, graphics, wording etc. G can be printed onto the substrate 11 (i.e. on surface 13) by normal printing methods such as screen printing, offset printing, photocopying, digital printing etc. Preferably, screen or digital printing is used because it provides a more desirable end result due to the greater/denser body of ink used.

Preferably the substrate is as thin as possible preferably in the range of 0.05 mm to 0.25 mm. As is known to the skilled person the thickness of the substrate is such as to avoid buckling (which can occur if the substrate is too thick) yet be thick enough to withstand the effects of the moulding procedure to be employed.

The adhesive system according to the invention in its broadest form includes a layer of a first adhesive (suitable for the desired end purpose of adhering the graphic to the mould surface) which overlays and is coupled to a layer of a second adhesive. In the preferred embodiment of the system the layers of adhesive are coupled via a planar carrier (preferable in the form of a film) with one adhesive layer on one side of the carrier and the other adhesive layer on the reverse (opposite) side of the carrier. The carrier and the respective adhesive layers adhere such that the adhesive layers remain adhered/fixed to the carrier during use of the adhesive system.

The carrier is preferably a high heat resistant plastics film.

Thus according to a preferred embodiment as illustrated a carrier film 14 has applied thereto a layer 15 of the first adhesive that will attach the graphic to the surface of the mould. On the other side of the carrier film 14 is applied a layer 17 of the second adhesive. The two layers 15 and 17 are thereby effectively overlaid and coupled together and are ready for use in say an in-mould application of a graphic to a moulded plastics article.

According to a preferred embodiment of the adhesive system of the invention the carrier film 14 is laminated with the adhesive layer 15 and the adhesive layer 17. The first adhesive layer 15 is preferably covered by a removable backing 16 as is the second adhesive layer 17 though in the drawing the backing on adhesive layer 17 is not shown because it has been removed to attach the adhesive system to the face surface 13 of the substrate 11.

The adhesive system can be supplied to an end user in say sheet or roll form and the user will generally cut a sufficiently sized section of the sheet for it to be attached to the surface 13 of the graphic substrate 11. This is achieved by removal of the backing on the adhesive layer 17 followed by pressing of the adhesive system onto the substrate 11 so that the adhesive layer 17 adheres to the surface 13 of the substrate 11. Typically the user would then trim any excess of the adhesive system from around the peripheral edge(s) of the graphic. However, for complex shaped graphics it may be preferable to carry out finishing work, i.e. die cutting, after the application of the adhesive system to the graphic.

The complete graphic 10 is thus ready for use in the moulding of a plastic material article.

The first step in the moulding process is to remove the release backing 16 from the graphic 10 in order to expose the adhesive layer 15.

The second step in the process is to apply the graphic 10 to the selected part of the surface of the mould so that the adhesive layer 15 adheres the graphic 10 to the surface of the mould. The surface of the mould must be clean and free from dust and extraneous material to achieve good adherence.

The third step in the process is to apply pressure to the surface 12 of the substrate to ensure that the graphic 10 is adhered over all of its area to the mould surface and the trapping of air is avoided.

The fourth step is to use a firm rubber faced roller or flat plastic squeegee to apply pressure over the whole graphic to ensure that the adhesive 15 has full contact with the mould surface.

With the graphic 10 thus installed in the mould the moulding cycle is undertaken.

Once the moulding cycle is completed the moulded article is removed from the mould. The strength of the bond between the graphic 10 and the moulded article is greater than the strength or adherence of the graphic to the mould surface created by the adhesive system thus the graphic 10 will release from the mould surface when the moulded article is removed from the mould.

Desirably the carrier 14 will remain in place on the graphic 10 when the moulded article is removed from the mould. This is because desirably the bond between the substrate 11 and film 14 created by the second adhesive 17 is greater than the strength or residual adherence of the first adhesive 15 with the mould surface. However, if it is less the film 14 will remain substantially adhered to the surface of the mould.

Thus when the moulded article has been removed from the mould it is simply a matter of removing the carrier film 14 by lifting an edge of the film 14 and peeling it away from the substrate 11 or mould surface as the case may be.

The adherence of the second adhesive 17 to the film 14 is greater than that to the surface 13 of the substrate 12 thus the removal of the carrier film 14 from the graphic removes the second adhesive 17 from the surface of the graphic 10 because the second adhesive 17 remains attached to the carrier film 14. As a result the moulded article is left free from any residual adhesive so that no cleaning of the surface 13 in a post moulding operation is required.

Likewise in the situation where the film 14 peels off the graphic when the article is removed from the mould, i.e. the film 14 remains adhered to the mould surface, the film 14 can be peeled from the mould and takes with it the adhesive/residual adhesive 15. This removal of adhesive 15 from the mould means that substantially no cleaning of adhesive from the mould will be required. In this situation the adherence of the film 14 to the mould means that as the film 14 is peeled/stripped from the graphic 10 during the removal of the article from the mould it takes with it the adhesive 17 resulting in no adhesive remaining on the graphic 10.

Thus the carrier 14 retains the adhesive layers 15 and 17 so that the two adhesives are removed from the mould surface and the graphic 10 thereby removing (or reducing) the need for a post moulding adhesive removal.

The skilled person will appreciate that in the preferred form of the invention:—

(a) the strength of the adhesive contact between the layers 15 and 17 and the carrier film 14 will be such that the layers 15 and 17 remain bonded to the carrier film 14;
(b) the strength of the bond between layer 15 and the mould surface when the article is removed form the mould will preferably be less than the bond between adhesive layer 17 and substrate 12; and
(c) the bond between the adhesive layer 17 and carrier 14 will be greater than that between adhesive layer 17 and substrate 12 so that the second adhesive 17 stays with the carrier 14 when the carrier 14 is peeled away from the substrate.

With the above balance of bonding between the components of the adhesive system the moulding process disclosed above can be achieved.

The adhesive used for layer 15 can be selected to suit the end purpose. The adhesive 15 can be a contact or touch/pressure sensitive adhesive. According to one form of the moulding process as described herein a proprietary brand touch sensitive glue can be used. An example of a suitable proprietary brand is GRIPIT and preferably 0086 type.

As is known in the art the substrate can be a synthetic paper such as of the type sold under the trade mark TESLIN. A description of this type of synthetic paper and its suitability for graphics of this type is made in NZ 286047 to which reference can be made.

In the preferred form of the adhesive product incorporating the present invention the carrier film 14 is a high heat resistant film. In the preferred form it is of a tensile strength such that the film will peel off in one piece.

In a preferred form of the invention the film 14 is formed from PET preferably a clear PET. Such a film is suitable for the end purpose as it is stable under high temperature and has good strength characteristics. Also a good bond with the adhesive layers 15 and 17 is achievable.

The film 14 is as thin as possible (preferably in the order of 0.5 mm) because the presence of the thickness of the film (as well as that of the easy peel adhesive) will result in the surface 13 of the graphic 10 being recessed into the finished moulded article. It is desirable to keep the depth of recess to a minimum though in some instances a slight recessing of the graphic surface could be advantageous as it may provide some degree of protection from abrasion.

It has been found that due to different shrinkages of the film 14 and the moulded article and graphic, the film 14 can become crinkled and partly separate from the graphic. However, while this can result in the film being aesthetically untidy in appearance it does provide the advantage that it facilitates gripping of the carrier 14 and make easier the peeling of the carrier from the graphic.

Any suitable adhesive can be used for the second adhesive layer 17. An example of one which is suitable for rotational moulding of plastic articles is a cross-linkable acrylic adhesive. In one form of the invention the first adhesive can also be of this type. To achieve the desired end result of the carrier remaining adhered to the graphic when the article is removed from the mould the second adhesive layer can be of a greater thickness than the layer of first adhesive such that the second adhesive is high tack and the layer of first adhesive is low tack. For example the thickness of the second adhesive can be in the order of 0.02 mm and the first adhesive thickness can be 0.01 mm. In an alternative construction the thickness of the two layers can be substantially the same.

The invention is open to modification. For example, the substrate could be a polyethylene film which may be clear or opaque.

The present invention has been described and illustrated by way of a specific embodiment. It is not the intention of the Applicant to restrict or in any way limit the scope of the invention to such an embodiment. Modifications and changes within the inventive concept will be apparent to the skilled person.

Therefore, the invention in its broader aspects is not limited to the specific details, representative means of manufacture and method, and illustrative examples shown and described in this specification. Accordingly departures may be made from such details without departing from the spirit or scope of the Applicant's general inventive concept.

What is claimed is:

1. An adhesive system which comprises a layer of a first adhesive overlaid and joined to a layer of a second adhesive.

2. An adhesive system as claimed in claim 1 wherein the layer of first adhesive and the layer of second adhesive are joined by being fixed to opposite surfaces of a planar carrier element.

3. An adhesive system as claimed in claim 2 wherein the carrier element is a high heat resistant plastics film.

4. An adhesive system as claimed in claim 3 wherein the plastics film is PET.

5. An adhesive system as claimed in claim 2 wherein the first adhesive is of lower tack than that of the second adhesive.

6. An adhesive system which includes a layer of a first adhesive, a layer of second adhesive, the first adhesive and the second adhesive being located and retained on respective opposite surfaces of a planar high heat resistant carrier.

7. An adhesive system as claimed in claim 6 wherein each of the exposed surfaces of each adhesive layer is covered by a removable backing material.

8. An adhesive system as claimed in claim 7 wherein the first adhesive is of lower tack than that of the second adhesive.

9. An adhesive system as claimed in claim 8 wherein the first and second adhesives are the same.

10. An adhesive system as claimed in claim 8 wherein the thickness of the layer of the first adhesive is less than the thickness of the layer of second adhesive.

11. An adhesive system as claimed in claim 8 wherein the first adhesive is a touch sensitive adhesive.

12. An adhesive system as claimed in claim 11 wherein the carrier is a high heat resistant plastics film such as a PET film.

13. An adhesive system as claimed in claim 12 wherein the PET film is clear.

14. A graphic which includes a substrate a surface of which has printing (such as graphics, indicia, wording and the like) applied thereto and to this printed surface is adhered the second adhesive side of an adhesive system according to claim 1 or 6.

15. A graphic as claimed in claim 14 wherein the substrate is a synthetic paper.

16. A graphic as claimed in claim 15 wherein the substrate is a clear material.

17. A process of in-mould application of a graphic to a moulded plastic article including the steps of applying to a printed surface of a graphic substrate the second adhesive side of an adhesive system according to the claim 1 or 6, adhering the graphic to a surface of the mould by way of the first adhesive, removing the moulded article from the mould at the completion of the moulding cycle and peeling the adhesive system from the graphic or the mould.
